(19) United States
(12) Patent Application Publication
(10) Pub. No.: US 2026/0164287 A1
(43) Pub. Date: Jun. 11, 2026

(54) Method and apparatus for transceiving a signal in a wireless communication system

(71) Applicant: Hanbat National University Industry-Academic Cooperation Foundation, Daejeon (KR)

(72) Inventors: Eunkyung KIM, Daejeon (KR); Gosan NOH, Daejeon (KR)

(21) Appl. No.: 19/408,993

(22) Filed: Dec. 4, 2025

(30) Foreign Application Priority Data
Dec. 5, 2024 (KR) 10-2024-0179333
Dec. 3, 2025 (KR) 10-2025-0189335

(51) Int. Cl. H04W 24/10; H04W 76/27

(52) U.S. Cl. CPC H04W 24/10; H04W 76/27

(57) ABSTRACT

The present disclosure provides an operating method of a terminal in a wireless communication system, which supports an XR service. More specifically, the operating method of the terminal includes: receiving RRC signaling related to RRM measurement from a base station; performing RRM measurement in a measurement interval configured for the RRM measurement based on the RRC signaling; and receiving, from the base station, DCI including information indicating whether to perform the RRM measurement in the measurement interval to provide an XR service without a delay.

### CROSS-REFERENCE TO RELATED APPLICATION

This application claims the benefit of and priority to Korean Patent Application No. 10-2024-0179333, filed on Dec. 5, 2024 and Korean Patent Application No. 10-2025-0189335, filed on Dec. 3, 2025, the entire disclosure(s) of which is hereby incorporated herein by reference in its entirety.

### TECHNICAL FIELD

The present disclosure relates to a method for transceiving a signal, i.e., data, and more particularly, to a method and an apparatus for transceiving data in a wireless communication system which supports extended reality (XR).

### BACKGROUND

In order to provide extended reality (XR) in a wireless communication system, complex XR video rendering calculations are performed at an application server based on control information received from a terminal. Strict quality of service (QOS) requirements are demanded in terms of round-trip delay time and throughput for transmitting video and control information.

It is important for the XR to always maintain a high-quality wireless link and to quickly predict and adapt to wireless channel changes. This is especially true in mobile communication bands (e.g., millimeter-wave bands) where channel and propagation characteristics are highly sensitive to user and environmental changes such as blockage, user movement, or rotation.

FIG. 1 is a diagram showing an example of a relationship between extended reality traffic generation and a measurement gap. Referring to FIG. 1, a problem arises where transceiving of XR traffic may be delayed due to a measurement gap configuration for RRM measurement. Korean Patent Publication No. 10-2023-0225880 discloses a method for identifying service flows for XR services in the wireless communication system and providing QoS information and policy information for service flows, but fails to disclose content for solving a problem of XR traffic transceiving being delayed due to measurement gaps, or a method for setting priorities of logical channels for simultaneously transceiving two or more data. Therefore, research is needed to solve the above problems in a wireless communication system supporting the XR service.

### SUMMARY

In view of the above, the present disclosure provides a method for explicitly indicating, by a base station, an operating method of a terminal to the terminal in a corresponding interval when RRM measurement and XR traffic transceiving overlap in a measurement gap for the RRM measurement.

Furthermore, the present disclosure provides a method for determining logical channels and logical channel priorities for corresponding data when transmission of two or more data occurs, such as in multimodal services.

The technical objects of the present disclosure are not limited to the aforementioned technical objects, and other technical objects, which are not mentioned above, will be apparently appreciated by a person having ordinary skill in the art from the following description.

The present disclosure provides an operating method of a terminal in a wireless communication system, which includes: receiving RRC signaling related to RRM measurement from a base station; performing RRM measurement in a measurement interval configured for the RRM measurement based on the RRC signaling; and receiving, from the base station, DCI including information indicating whether to perform the RRM measurement in the measurement interval.

Further, in the present disclosure, the DCI further includes resource allocation information related to data transceiving.

In addition, in the present disclosure, when the data transceiving and the RRM measurement overlap in a measurement interval, the information indicating whether to perform the RRM measurement is configured not to perform the RRM measurement.

In addition, in the present disclosure, the RRM measurement is not performed in the overlapping measurement interval based on the information indicating whether to perform the RRM measurement.

In addition, in the present disclosure, the data transceiving includes transceiving of a plurality of data.

Further, in the present disclosure, the method further includes: determining a priority of a logical channel related to the plurality of data; and adjusting the priority of the logical channel for a portion of data among the plurality of data.

In addition, in the present disclosure, the adjusted priority of the logical channel for the portion of data is configured to be higher than a priority of a logical channel of other data. Further, in the present disclosure, the portion of data is data for which resources are reallocated due to less resource allocation than a data size of the plurality of data.

In addition, in the present disclosure, the method further includes: performing retransmission for the transceiving of the data; and adjusting a priority of a logical channel for data related to the retransmission.

Further, in the present disclosure, the priority of the logical channel for the data related to the retransmission is configured to be higher than the priority of the logical channel of other data.

In addition, the present disclosure provides a terminal including: a memory; an RF module transceiving a wireless signal with the outside; and a processor functionally connected to the memory and the RF module, and controlling an overall operation of the terminal, and the processor controls to receive RRC signaling related to RRM measurement from a base station, perform RRM measurement in a measurement interval configured for the RRM measurement based on the RRC signaling, and receive DCI including information indicating whether to perform the RRM measurement in the measurement interval from the base station.

### ADVANTAGEOUS EFFECTS

According to the present disclosure, there is an effect in which an operation of the terminal for the RRM measurement and the XR traffic transceiving is defined and a priority of a logical channel for transmitting two or more data is defined to provide an XR service without a delay.

Advantages which can be obtained in the present disclosure are not limited to the aforementioned effects and other unmentioned advantages will be clearly understood by those skilled in the art from the following description.

### BRIEF DESCRIPTION OF THE DRAWINGS

The accompany drawings, which are included to provide a further understanding of the present disclosure and are incorporated on and constitute a part of this specification illustrate embodiments of the present disclosure and together with the description serve to explain the principles of the present disclosure.

FIG. 1 is a diagram showing an example of a relationship between extended reality traffic generation and a measurement gap.

FIG. 2 shows one example of a conceptual diagram of a wireless communication system to which a method proposed by the present disclosure may be applied.

FIG. 3 shows a block diagram of a wireless device according to an embodiment of the present disclosure.

FIG. 4 is a flowchart showing an example of an operating method of a terminal for implementing the method proposed by the present disclosure.

FIG. 5 is a flowchart showing another example of the operating method of the terminal for implementing the method proposed by the present disclosure.

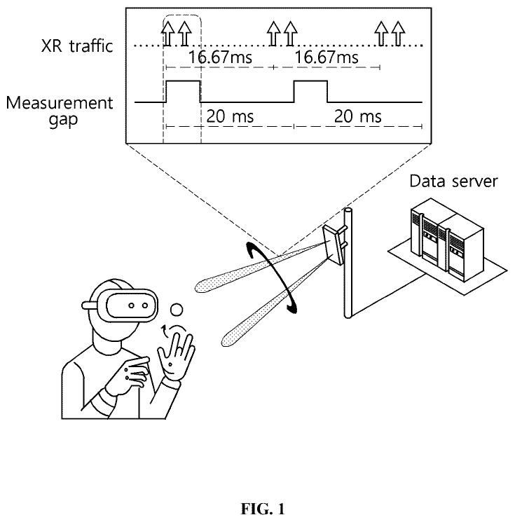

### DETAILED DESCRIPTION

It is noted that technical terms used in the present disclosure are used to just describe a specific embodiment and do not intend to limit the spirit of the technology disclosed in the present disclosure. Further, unless the technical terms used in the present disclosure are particularly defined as other meanings in the present disclosure, the technical terms should be appreciated as meanings generally appreciated by those skilled in the art in a field to which the technology disclosed in the present disclosure pertains and should not be appreciated as excessively comprehensive meanings or excessively reduced meanings. Further, when the technical term used in the present disclosure is a wrong technical term that cannot accurately express the spirit of the technology disclosed in the present disclosure, the technical term is substituted by a technical term which can be correctly appreciated by those skilled in the art in the field to which the technology disclosed in the present disclosure pertains to be appreciated. In addition, a general term used in the present disclosure should be interpreted as defined in a dictionary or contextually, and should not be interpreted as an excessively reduced meaning.

Terms including ordinal numbers, such as first, second, etc., used in the present disclosure can be used to describe various components, but the components should not be limited by the terms. The terms are used only to discriminate one component from another component. For example, a first component may be named as a second component and similarly, the second component may also be named as the first component without departing from the scope of the present disclosure.

Hereinafter, embodiments disclosed in the present disclosure will be described in detail with reference to the accompanying drawings and the same or similar components are denoted by the same reference numerals regardless of a sign of the drawing, and duplicated description thereof will be omitted.

Further, in describing the technology disclosed in the present disclosure, a detailed description of related known technologies will be omitted if it is determined that the detailed description makes the gist of the technology of the present disclosure unclear. Further, it is noted that the accompanying drawings are used just for easily appreciating the spirit of the technology of the present disclosure and it should not be analyzed that the spirit of the technology is limited by the accompanying drawings.

Among the terms used in the present disclosure, ‘configuration’ may be referred to as ‘operation’, ‘proposal’, ‘instruction’, etc., ‘transmission/reception’ may be referred to as ‘Tx/Rx’, ‘transmission/reception’, etc., and ‘A/B’ may be interpreted as ‘including at least one of A or B’.

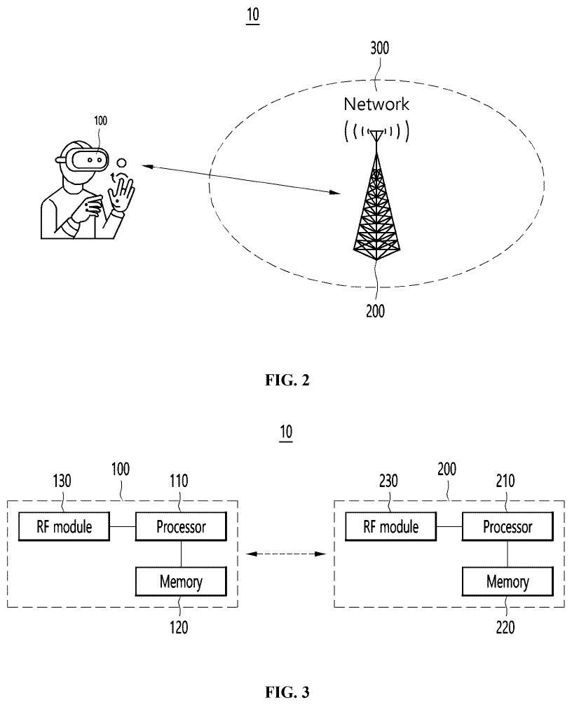

FIG. 2 shows one example of a conceptual diagram of a wireless communication system to which a method proposed by the present disclosure may be applied.

Referring to FIG. 2, the wireless communication system 10 includes a wireless device 100, a base station 200, and a network 300.

The base station 200 and the network 300 may be implemented as wireless devices, and a specific wireless device may operate as a base station/network node with respect to another wireless device.

The wireless device 100 represents a device that performs communication using Radio Access Technology (RAT) (e.g., 4G, 5G, 6G, etc.). The wireless device may include robots, vehicles, eXtended Reality (XR) devices, hand-held devices, Internet-of-Things (IOT) devices, and Artificial Intelligence (AI) devices/servers. The XR device may include Augmented Reality (AR)/Virtual Reality (VR)/Mixed Reality (MR) devices, and may be implemented in the form of Head-Mounted Devices (HMDs) and Head-Up Displays (HUDs) mounted on vehicles, televisions, smartphones, computers, wearable devices, home appliances, digital signage, vehicles, robots, etc. The hand-held devices may include smartphones, smart pads, wearable devices (e.g., smart watches or smart glasses), and computers (e.g., laptops).

In the present disclosure, the wireless devices may be referred to as terminals or User Equipment (UE). The terminals may include, for example, mobile phones, smartphones, laptop computers, digital broadcasting terminals, Personal Digital Assistants (PDAs), Portable Multimedia Players (PMPs), navigation systems, slate PCs, tablet PCs, ultrabooks, vehicles, vehicles with autonomous driving functions, connected cars, UAVs, AI modules, robots, AR devices, VR devices, MR devices, hologram devices, public safety devices, MTC devices, IoT devices, medical devices, fintech devices (or financial devices), security devices, and weather/environmental devices.

For example, the VR devices may include devices for implementing objects or backgrounds of virtual environments. For example, the AR devices may include devices implemented by connecting virtual world objects or backgrounds to real world objects or backgrounds. For example, the MR devices may include devices implemented by merging objects or virtual world backgrounds with objects or real world backgrounds. For example, the hologram devices may include devices for implementing 360-degree stereoscopic images by recording and reproducing stereoscopic information using a light interference phenomenon that occurs when two laser lights called holograms meet.

The wireless device 100 may be connected to the network 300 through the base station 200. AI technology may be applied to the wireless device, and the wireless device may be connected to an AI server through the network 300.

Wireless communication/connection may be established between wireless devices and/or between the wireless device and the base station 200 and/or between the base stations 200. Here, the wireless communication/connection may be established through various RATs (e.g., 5G, 6G, etc.) such as uplink/downlink communication, sidelink communication (or Device-To-Device (D2D) communication), inter-base station communication (e.g., relay, Integrated Access and Backhaul (IAB)), and the like. Through the wireless communication/connection, the wireless device 100 and the base station 200 may transmit/receive wireless signals to/from each other. For example, the wireless communication/connection may transmit/receive signals through various physical channels. To this end, based on various proposals of the present disclosure, at least some of various configuration information configuration processes for transmitting/receiving wireless signals, various signal processing processes (e.g., channel encoding/decoding, modulation/demodulation, resource mapping/demapping, etc.), and resource allocation processes may be performed.

FIG. 3 shows a block diagram of a wireless device according to an embodiment of the present disclosure.

Referring to FIG. 3, the wireless communication system 10 includes a terminal 100 and a base station 200.

The terminal and the base station may also be expressed as wireless devices, and the base station may be expressed as a transmitting end, a transmitter, a transmitting device, a TRP, etc., and the terminal may be expressed as a receiving end, a receiver, a receiving device, the TRP, etc.

The terminal 100 includes a processor 110, a memory 120, and an RF module 130. The processor implements a function, a process, and/or a method which are proposed by the present disclosure to be described below. Layers of a wireless interface protocol may be implemented by the processor. The memory is connected to the processor to store various information for driving the processor. The RF module is connected to the processor to transmit and/or receive a wireless signal.

The base station 200 includes a processor 210, a memory 220, and an RF module 230.

The processor implements a function, a process, and/or a method which are proposed by the present disclosure to be described below. Layers of a wired/wireless interface protocol may be implemented by the processor. The memory is connected to the processor to store various information for driving the processor. The RF module is connected to the processor to transmit and/or receive a wired/wireless signal.

The RF module may include an antenna for transmitting/receiving the wireless signal.

The memories 120 and 220 may be positioned inside or outside the processors 110 and 210 and connected with the processor by various well-known means.

Next, measurement performance and a logical channel priority will be briefly examined, and the method proposed by the present disclosure will be examined in more detail together with a content described below.

The terminal may receive, from the base station, a measurement configuration (or “measConfig”) information element (IE) of a cell through RRC signaling. The measurement configuration IE may include a measGapConfig field for configuring a measurement gap.

One of the functions of the MAC layer is to prioritize logical channels. The MAC layer may receive MAC SDUs (i.e., RLC protocol data units (PDUs)) from different logical channels coming from the RLC layer. The MAC layer then multiplexes these MAC SDUs onto a single transport channel (e.g., UL-SCH).

MAC SDUs are prioritized and selected from different logical channels. The logical channel prioritization procedure may be applied when a new MAC transmission is performed. The RRC layer may control scheduling of uplink data by assigning a priority which represents a priority level that decreases as a priority value increases to each logical channel. Further, each logical channel is configured using a prioritized bit rate (PBR) and optionally using a maximum bit rate (MBR).

An MAC PDU may include an MAC SDU, an MAC control element, and padding. Both the MAC header and the MAC SDU are formed with variable sizes. The header of a MAC PDU contains one or more MAC PDU subheaders, and each of the MAC PDU subheaders corresponds to the MAC SDU, the MAC control element, or the padding. The MAC layer may generate the MAC control element such as a buffer status report control element. The MAC control element is identified through a specific value for logical channel identification (LCID).

Hereinafter, a method for exchanging signaling information for providing an XR service in the wireless communication system proposed by the present disclosure will be examined.

The triggering (or activation) of RRM measurement by network signaling in a gap/restriction between transmission and reception caused by the Radio Resource Management (RRM) may be accomplished by at least one or two or more combinations of the RRC message, the MAC CE, and the DCI.

If transceiving and RRM measurement time must be performed simultaneously, unless there is a special instruction, the following (1) or (2) may be configured (or operated) or preconfigured.
(1) The base station may configure the terminal to perform transceiving at the corresponding time point and not perform the RRM measurement, or may be preconfigured so that the RRM measurement is not performed.
(2) The base station may configure the terminal to perform the RRM measurement without performing transceiving at the corresponding time point, or the RRM measurement may be preconfigured.

In the above case, an RRM measurement interval may be configured as a preconfigured interval or in the form of a specific slot, frame, or window (interval). In addition, when the base station allocates resources to the terminal through the DCI or the like, the DCI may include information indicating whether to perform the RRM measurement in the RRM measurement interval to allocate the resources to the terminal.

Alternatively, when the resource allocation information included in the DCI duplicates (or overlaps) with the corresponding RRM measurement interval, the base station may instruct the terminal to skip performing the RRM measurement. In the present disclosure, “terminal to skip performing” is interpreted as “terminal not to perform the RRM measurement”.

Since a time delay occurs due to a gap/limitation between the transceiving and the RRM measurement, the terminal may configure (or instruct) the terminal to skip performing the RRM measurement during a corresponding interval. Alternatively, when resource allocation for transceiving is not made, the base station may be configured to instruct the terminal with a predefined fixed time or explicit time so that RRM measurement may be attempted when the instructed time elapses. Furthermore, instead of configuring each terminal individually, the configuration may be made according to an application service serving the terminal or separately for two or more terminals providing a specific service.

In another embodiment, the method proposed by the present disclosure may be usefully applied to two or more RRM measurement configurations (e.g., Inter-frequency RRM and CSI-RS RRM). That is, in a specific situation, the base station may be configured to omit Inter-frequency RRM and to perform channel measurement for data transceiving.

Further, the configuration may be semi-statically made for reducing frequent signaling, for data transmissions occurring at a certain moment, or for other purposes.

When a time for measuring the RRM is limited or time points for limiting transceiving intervals occur at regular intervals, the base station may indicate this fact (or configuration) to the terminal at the corresponding time point to propose (or operate) an operation at an overlapping time point of the transceiving and the RRM measurement in the corresponding interval at the corresponding time point. In this case, when operating until the corresponding time point ends, if the configuration needs to be changed or if a change occurs at an arbitrary time point, the configuration may be made while the aforementioned fact (configuration change or occurrence of change at an arbitrary time point) is included in the DCI, etc. That is, the configuration may be more flexibly made at an arbitrary time point during the corresponding interval.

As another method, the base station and the terminal may be operated by additionally indicating the corresponding interval at the corresponding time point, i.e., a time during which the configuration is valid, or by considering the configuration to be valid until information to cancel the configuration is transmitted.

Meanwhile, in the case of data that is guaranteed to be transmitted at a given time or data that has a priority over other data, there may be a case where transmission may not be guaranteed due to the RRM measurement, etc. In this case, the terminal may be instructed or configured at an initial or arbitrary time point to ignore the above-mentioned signaling for such data and to transceive data even when the signaling is received. This may be maintained until the end of the service or be valid for a specific interval (or time).

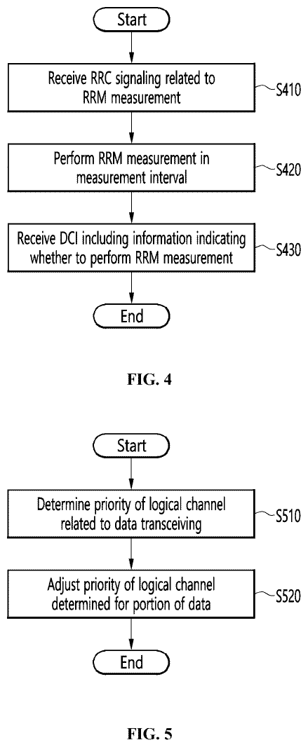

FIG. 4 is a flowchart showing an example of an operating method of a terminal for implementing the method proposed by the present disclosure.

First, the terminal receives RRC signaling related to RRM measurement from the base station (S410).

The RRC signaling may include a measurement configuration IE containing measurement gap configuration information or may be a measurement configuration IE.

In addition, the terminal performs RRM measurement in a measurement interval configured for the RRM measurement based on the RRC signaling (S420).

In addition, the terminal receives, from the base station, DCI including information indicating whether to perform the RRM measurement in the measurement interval (S430).

The information indicating whether to perform the RRM measurement represents information indicating to perform the RRM measurement or indicating to skip performing the RRM measurement.

The DCI received by the terminal in step S430 may include resource allocation information related to data transceiving.

In step S430, when the information indicating whether to perform the RRM measurement included in the DCI received by the terminal indicates to skip performing the RRM measurement, the terminal does not perform the RRM measurement in the measurement interval where the data transceiving and the RRM measurement overlap.

Next, a method for providing a multimodal service in the wireless communication system proposed by the present disclosure will be described.

In the wireless communication system proposed by the present disclosure, a transmitting end (e.g., a base station or terminal) may provide the multimodal service, etc., through transmission of two or more data. In this case, the two or more data may have the same priority or may be configured with different priorities, and provided. In this case, the transmitting end may configure and provide each data as either (1) the same logical channel (LC) or (2) a logical channel (LC) for each data.

When the same logical channel is applied to two or more data, the wireless communication system proposed by the present disclosure may provide a service based on a legacy scheme. However, when the service is provided through two or more LCs, efficient service provision may be achieved by applying the following.

In a 3GPP standard, when data transmission occurs, the LC is determined by considering a subcarrier spacing index, PUSCH transmission duration, cell information, etc. However, when a service is provided only by transmitting two or more data (e.g., multimodal service), a difference may occur at a time point at which the two or more data are transmitted.

In this case, a service priority of the LC determined for specific data may be determined by a logical channel priority (LCP). In particular, when managing two or more LCs, the transmitting end must manage and configure each LC separately for operations such as RRM or data allocation. In this case, more detailed processing or management is possible by performing configuration (or management) for each data. However, for service provision through two or more data, the transmitting end must transmit the two or more data simultaneously in time or within a predetermined allowable time so that the data are delivered to the receiver. To this end, the transmitting end may configure the same LCP for two or more data items. This may be applied when two or more data have different generation patterns, and when the transmitting end attempts to transmit data to the receiving end at the same time point, a plurality of data may be enabled to be simultaneously transmitted.

Meanwhile, when the LCP is configured differently to reflect data-specific patterns, etc., an operation thereof is necessary when simultaneously providing the service (or performing data transmission). To this end, data with a higher LCP priority may be generally serviced preferentially.

However, when requesting and allocating resources for data transmission, the transmitting end may allocate resources that do not match (e.g., are insufficient for) a size of the data corresponding to the LCP due to limited data resources. First, when resources for data allocation corresponding to a specific LCP are insufficient and only some are allocated, data corresponding to the LCP may be given a highest possible priority for reallocation so that data transmission may be performed as quickly as possible. Further, when multiple LCs are configured and operated for a corresponding terminal, data reallocated and transmitted regardless of the LCP may be transmitted through another LC even if resources are not allocated to the corresponding LC for data allocation corresponding to the specific LCP. To this end, the receiving end that receives the data requires an additional procedure to check data in the LC to confirm this fact. In this case, the transmitting end may explicitly notify the receiving end of this fact using a data header (e.g., MAC CE). In particular, in the case of retransmission, when reusing a previous LCP, management with priorities corresponding to other LCs may be required. In this case, when retransmission must be guaranteed for service provision or is predefined to guarantee the priority, the transmitting end may need to guarantee data allocation more than other data services. In this case, the transmitting end may guarantee data transmission by designating the LCP with a priority higher than a predetermined priority. Furthermore, the transmitting end may guarantee data transmission identical to a high-priority LC without changing a previously selected (or configured) LCP in the case of retransmission, even if the priority of the previous data transmission is low.

Alternatively, the transmitting end may select (or configure) a separate LC and a separate LCP for retransmission to reduce a retransmission delay or guarantee a delay time.

Furthermore, when a data characteristics result in a relatively long time between initial data transmission and subsequent data transmission, the previous LC may be maintained as it is, and the separate LC may be provided for management so that when new data transmission occurs, the previous configuration continues to operate. This provides an advantage of reducing a service delay and enables a continuous service by persistently applying a previously configured service scheduling method.

FIG. 5 is a flowchart showing another example of the operating method of the terminal for implementing the method proposed by the present disclosure.

First, the terminal determines a priority of a logical channel related to data transceiving (S510).

Here, the data transceiving may include transceiving of two or more data, that is, a plurality of data.

In the case of transceiving the plurality of data, the terminal adjusts (or modifies) the priority of the logical channel determined in step S510 for a portion of data among the plurality of data (S520).

A case of performing step S520 may be a case where resource allocation becomes less than a data size of the plurality of data such that resource reallocation is performed for a portion of data among the plurality of data.

Here, the priority of the logical channel adjusted through step S520 for the portion of data may be set higher than the priority of the logical channel of other data.

Additionally, the terminal may perform retransmission for the transceiving of the data, and may control the priority of the logical channel in the retransmission by setting the priority of the logical channel for the data related to the retransmission higher than the priority of the logical channel of other data.

In the embodiments described above, the components and the features of the present disclosure are combined in a predetermined form. Each component or feature should be considered as an option unless otherwise expressly stated. Each component or feature may be implemented so as not to be associated with other components or features. Further, the embodiment of the present disclosure may be configured by combining some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by various means, for example, hardware, firmware, software, or combinations thereof. In the case of implementation by hardware, according to hardware implementation, the embodiment of the present disclosure may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present disclosure may be implemented in the form of a module, a procedure, a function, and the like which perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all respects and should be exemplarily considered. The scope of the present disclosure should be determined by rational construing of the appended claims and all modifications within an equivalent scope of the present disclosure are included in the scope of the present disclosure.

### DETAILED DESCRIPTION OF MAIN ELEMENTS

10: Wireless communication system

What is claimed is:

1. An operating method of a terminal in a wireless communication system, comprising:
receiving RRC signaling related to RRM measurement from a base station;
performing RRM measurement in a measurement interval configured for the RRM measurement based on the RRC signaling; and
receiving, from the base station, DCI including information indicating whether to perform the RRM measurement in the measurement interval.

2. The method of claim 1, wherein the DCI further includes resource allocation information related to data transceiving.

3. The method of claim 2, wherein when the data transceiving and the RRM measurement overlap in a measurement interval, the information indicating whether to perform the RRM measurement is configured to skip performing the RRM measurement.

4. The method of claim 3, wherein the RRM measurement is not performed in the overlapping measurement interval based on the information indicating whether to perform the RRM measurement.

5. The method of claim 1, wherein the data transceiving includes transceiving of a plurality of data.

6. The method of claim 5, further comprising:
determining a priority of a logical channel related to the plurality of data; and
adjusting the priority of the logical channel for a portion of data among the plurality of data.

7. The method of claim 6, wherein the adjusted priority of the logical channel for the portion of data is configured to be higher than a priority of a logical channel of other data.

8. The method of claim 6, wherein the portion of data is data for which resources are reallocated due to less resource allocation than a data size of the plurality of data.

9. The method of claim 1, further comprising:
performing retransmission for the transceiving of the data; and
adjusting a priority of a logical channel for data related to the retransmission.

10. The method of claim 9, wherein the priority of the logical channel for the data related to the retransmission is configured to be higher than the priority of the logical channel of other data 11. A terminal comprising:
a memory;
an RF module transceiving a wireless signal with the outside; and
a processor functionally connected to the memory and the RF module, and controlling an overall operation of the terminal,
wherein the processor controls to receive RRC signaling related to RRM measurement from a base station, perform RRM measurement in a measurement interval configured for the RRM measurement based on the RRC signaling, and receive DCI including information indicating whether to perform the RRM measurement in the measurement interval from the base station.

12. The terminal of claim 11, wherein when the data transceiving and the RRM measurement overlap in a measurement interval, the information indicating whether to perform the RRM measurement is configured to skip performing the RRM measurement.

13. The terminal of claim 12, wherein the processor controls to skip performing the RRM measurement in the overlapping measurement interval based on the information indicating whether to perform the RRM measurement.

14. The terminal of claim 11, wherein the data transceiving includes transceiving of a plurality of data, and
the processor determines a priority of a logical channel related to the plurality of data; and
adjusts the priority of the logical channel for a portion of data among the plurality of data.

15. The terminal of claim 11, wherein the processor performs retransmission for the transceiving of the data; and adjusts a priority of a logical channel for data related to the retransmission.
